(19) United States
(12) Patent Application Publication
(10) Pub. No.: US 2008/0069939 A1
(43) Pub. Date: Mar. 20, 2008

(54) SOLID, UNIT DOSE, SWEETENING COMPOSITIONS

(76) Inventors: Steven J. Catani, Athens, GA (US); Melanie Loades, West Byfleet (GB); Joseph Panarisi, Perrineville, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/532,887

(22) Filed: Sep. 18, 2006

(51) Int. Cl. A23L 1/236

(52) U.S. Cl. 426/548

(57) ABSTRACT

Unit dose sweetening compositions containing a sweetener, a low Glycemic Index carbohydrate, and one or more flavor or aroma components are provided. More particularly, a solid, unit dose, sweetening composition containing a sweetener that provides at least about one gram of SES to the composition, at least about one gram of a low Glycemic Index carbohydrate per teaspoon of SES, and at least one flavor or aroma, wherein the sweetening composition has the following properties: i) a volume greater than about 0.03 cm³ per gram of SES; ii) requires a pressure of less than about 200 g/mm² to be crushed into smaller solid particles; and iii) contains less than about 3 kilocalories per gram of SES is provided. Also provided are methods of customizing the taste of a foodstuff using such sweetening compositions, kits containing such sweetening compositions, and methods of customizing the taste of a foodstuff using such kits. Methods of assessing a sweetness profile of an individual using such kits and customized sweetness delivery systems designed using such methods are also provided.

### FIELD OF THE INVENTION

The present invention relates to compositions containing a sweetener, a low Glycemic Index carbohydrate, and at least one flavor or aroma component. More particularly, the present invention relates to a solid, unit dose, sweetening composition containing a sweetener that provides at least about one gram of sucrose equivalent sweetness (“SES”) to the composition, at least about one gram of a low Glycemic Index carbohydrate per teaspoon of SES, and at least one flavor or aroma component, wherein the sweetening composition has a volume greater than about 0.03 cm³ per gram of SES, requires a pressure of less than about 200 g/mm² to be crushed into smaller particles, and contains less than about 3 kilocalories per gram of SES. The present invention also relates to methods of customizing the taste of a foodstuff using such sweetening compositions, kits containing such sweetening compositions, and methods of customizing the taste of a foodstuff using such kits. The present invention further relates to methods of assessing a sweetness profile of an individual using such kits and customized sweetness delivery systems designed using such methods.

### BACKGROUND OF THE INVENTION

People often add sweeteners to their foods and beverages. For example, sweeteners are added to beverages, such as, coffee and tea. Sweetening a food or beverage alters its flavor and usually increases its appeal. This behavior is found in all cultures, but is especially prevalent in western cultures.

Sweeteners are generally grouped into two categories—nutritive and high intensity sweeteners. The most common sweeteners are nutritive sweeteners. Nutritive sweeteners not only provide sweetness, but are also absorbable into the bloodstream and may be metabolized to provide energy for immediate use or for storage as fat. Nutritive sweeteners are typically extracted from plants that produce them in various quantities and for various purposes. For example, sucrose, a nutritive sweetener in widespread use, is produced from, e.g., sugar cane and sugar beet roots.

Sugar alcohols are another form of sweetener. Sugar alcohols are derived from sugar molecules and as used herein carbohydrates. Sugar alcohols vary in sweetness from half as sweet to about as sweet as sucrose. Accordingly, sugar alcohols may be used in place of sugar. Sugar alcohols have about one-half to three-quarters the amount of calories of sugar on a per weight basis. Sugar alcohols are slowly and incompletely absorbed from the small intestine into the blood. Absorbed sugar alcohols are converted to energy by processes that require little or no insulin. Accordingly, these sweeteners may be used by diabetics or those on low-carbohydrate diets.

High intensity sweeteners are well known alternatives to nutritive sweeteners. High intensity sweeteners provide sweetness without the calories and other metabolic impacts of the nutritive sweeteners. In many cases, high intensity sweeteners provide a sweet flavor that is preferred to, e.g., nutritive sweeteners. Some high intensity sweeteners, such as, aspartame, are nutritive, but are so intensely sweet that in practical use they provide negligible calories because very small amounts are required. Other high intensity sweeteners, such as, sucralose, are not absorbed when ingested and are, therefore, non-nutritive sweeteners.

Most foods engage more than one sense when consumed. Coffee, for example, has a both a taste and a distinct scent, which is essential to its sensory experience. Often, a coffee drinker's sensory experience begins well before the coffee is even poured. Likewise, meats and poultry, for example, have not only a taste and a scent, but also a texture, which is essential to their sensory experience.

Sucrose is the standard against which other sweeteners are measured. Sucrose is odorless, most often dissolved in a foodstuff and, therefore, has little effect on texture. Sucrose is generally used in conjunction with other foods that impart other sensory attributes. Work to improve sweeteners, both nutritive and non-nutritive, has been directed to mimicking sucrose and has been concerned with only one sense—taste. Each high intensity sweetener has inherent factors which determine its taste, and each has a set of consumers, which find that taste most acceptable. Most development, however, has been focused on modifying the inherent properties of a sweetener to more closely match the sensory attributes of sucrose. Saccharine, for example, has a bitter taste compared to sucrose. Accordingly, methods have been developed to remove this bitter note, e.g., by adding cream of tartar. Sucralose has a sweetness that remains in the mouth longer than that of sucrose and methods to remove this sweet linger have been developed, e.g., by adding 2,4-dihydroxybenzoic acid.

Accordingly, it would be advantageous to provide a composition that allows consumers to optimized the taste of a food or beverage. In particular, it would be advantageous to provide compositions that are optimized to match the application they will be used in or the actual preference of the consumer. In this way the sweetener is optimized to the application, rather than the application optimized to the a common sweet taste, i.e., sucrose.

### SUMMARY OF THE INVENTION

One embodiment of the present invention is a solid, unit dose, sweetening composition comprising, consisting of and/or consisting essentially of a sweetener that provides at least about one gram of SES to the composition, at least about one gram of a low Glycemic Index carbohydrate per teaspoon of SES, and at least one flavor or aroma component, wherein the sweetening composition has the following properties: i) a volume greater than about 0.03 cm³ per gram of SES; ii) requires a pressure of less than about 200 g/mm² to be crushed into smaller solid particles; and iii) contains less than about 3 kilocalories per gram of SES.

Another embodiment of the present invention is a method of customizing the taste of a foodstuff. This method comprising, consisting of and/or consisting essentially of the steps of combining the foodstuff with a solid, unit dose, sweetening composition containing a sweetener that provides at least about one gram of SES to the composition, at least about one gram of a low Glycemic Index carbohydrate or a soluble fiber per teaspoon of SES, and at least one flavor or aroma component.

An additional embodiment of the present invention is a kit comprising, consisting of and/or consisting essentially of, in packaged combination, a plurality of unit dose, sweetening compositions and instructions for their use, each sweetening composition containing a sweetener that provides at least about one gram of SES to the composition, at least about one gram of a low Glycemic Index carbohydrate per teaspoon of SES, and at least one flavor or aroma component, wherein a flavor of at least one unit dose in the kit differs from a flavor of at least one other unit dose in the kit.

A further embodiment of the present invention is a method of customizing the taste of a foodstuff. This method comprising, consisting of and/or consisting essentially of the steps of providing a kit of the present invention, selecting at least one unit dose, and combining the at least one unit dose with a foodstuff.

Another embodiment of the present invention is a method of assessing a sweetness profile of an individual and designing a customized sweetness delivery system for the individual. This method comprises, consists of and/or consists essentially of providing a kit containing, in packaged combination, a plurality of unit dose, sweetening compositions and instructions for their use. Each sweetening composition contains a sweetener that provides at least about one gram of SES to the composition, at least about one gram of a low Glycemic Index carbohydrate per teaspoon of SES, and at least one flavor or aroma component, wherein each unit dose provides a unique flavor. The method further comprises, consists of and/or consists essentially of separately incorporating each unit dose into a sample of a foodstuff, determining the individual's preference for each of the unit dose flavors when combined with a sample of the foodstuff, correlating the individual's preferences for each flavor or aroma, and designing a customized sweetness delivery system based on the observed correlations.

An additional embodiment of the present invention is a customized sweetness delivery system in the form of a kit comprising, consisting of and/or consisting essentially of in packaged combination, a plurality of unit dose, sweetening compositions and instructions for their use. Each sweetening composition comprises consists of and/or consists essentially of a sweetener that provides at least about one gram of SES to the composition, at least about one gram of a low Glycemic Index carbohydrate per teaspoon of SES, and at least one flavor or aroma component. The composition of the unit doses in the system are determined by carrying out the method of assessing a sweetness profile of an individual described above.

### DETAILED DESCRIPTION OF THE INVENTION

One embodiment of the present invention is a solid, unit dose, sweetening composition containing a sweetener that provides at least about one gram of SES (“SES”) to the composition, at least about one gram of a low Glycemic Index carbohydrate per teaspoon of SES, and at least one flavor or aroma component, wherein the sweetening composition has the following properties: i) a volume greater than about 0.03 cm³ per gram of SES; ii) requires a pressure of less than about 200 g/mm² to be crushed into smaller solid particles; and iii) contains less than about 3 kilocalories per gram of SES.

### Sweeteners

As used herein, the term “sweetener” means any food-grade substance that produces a sweet taste when consumed.

As used herein, the term “nutritive sweetener” means a substance that provides sweetness and is also absorbable into the bloodstream and may be metabolized to provide energy for immediate use or for storage as fat. Nutritive sweeteners are typically extracted from plants that produce them in various quantities and for various purposes. For example, sucrose, a nutritive sweetener in widespread use, is produced from, e.g., sugar cane and sugar beet roots. Examples of nutritive sweeteners useful in the present invention include, e.g., corn syrup, glucose, fructose, tagatose, high fructose corn syrup, lactose, sucrose, trehalose, lactose, arabinose, trehalose, maltodextrin, soluble starch, insulin, and the like, alone or in combination.

As used herein, the term “high intensity sweetener” means a substance that provides a high sweetness per unit mass compared to a nutritive sweetener and provides little or no nutritive value. Many high intensity sweeteners are known to those skilled in the art and any may be used in the present invention. Examples of high intensity sweeteners useful in the present invention include, for example, aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, extracts of sweet plants, such as stevia, thaumatin, salts, and combinations thereof. A preferred high intensity sweetener according to the present invention is sucralose.

As used herein, the term “sugar alcohol” means a food-grade alcohol derived from a sugar molecule. Sugar alcohols useful in the present invention include, for example, isomalt, erythritol, hydrogenated isomaltulose, hydrogenated starch hydrolyzates, lactitol, maltitol, mannitol, sorbitol, xylitol, and combinations thereof.

As used herein, a “food-grade” material is one that conforms to the standards for foods deemed safe for human consumption set forth in the Codex Alimentarius produced by the World Health Organization (1999).

As used herein, a gram (or other given amount) of Sucrose Equivalent Sweetness (“SES”) means the amount of high intensity sweetener needed to be added to an 8 ounce glass of water in order to provide the same sweetness as an independent 8 ounce glass of water containing one gram (or the other given amount) of sucrose. For example, 1/200 g of aspartame will equal about one gram of SES because aspartame is about 200 times sweeter than sucrose. Similarly, about 1/500 g to about 1/600 g of sucralose will provide one gram of SES because sucralose is about 500 to about 600 times sweeter than sucrose.

As used herein, all numerical ranges provided are intended to expressly include at least all numbers that fall between the endpoints of ranges.

Preferably, the sweetening compositions of the present invention contain from about 1 gram to about 10 grams of SES. More preferably, the sweetening compositions of the present invention contain from about 1 grams to about 5 grams of SES.

### Glycemic Index Carbohydrates

As used herein, the term “low Glycemic Index carbohydrate” means a food-grade carbohydrate with a Glycemic Index 55 or less. Low Glycemic Index carbohydrates useful in the present invention include, for example, fructooligosaccharide, soluble fiber, glucooligosaccharide, inulin, galactooligosaccharide, erythritol, tagatose, and combinations thereof. A preferred low Glycemic Index carbohydrate according to the present invention is fructooligosaccharide.

The Glycemic Index quantifies the differences between carbohydrates by ranking the carbohydrates according to their effect on blood glucose levels. Low Glycemic Index carbohydrates are ones that produce only small fluctuations in blood glucose and insulin levels. The method of determining the Glycemic Index for a food is provided by AOAC International.

Consuming large quantities of high Glycemic Index foods may be detrimental to one's health because these foods create large swings in blood glucose levels. This is especially true if an individual is overweight and sedentary or diabetic. In contrast, low Glycemic Index carbohydrates slowly trickle glucose into the bloodstream and keep energy levels balanced. Accordingly, low Glycemic Index diets help people maintain healthy blood sugar levels.

Preferably, the sweetening compositions of the present invention contain from about 1 gram to about 10 grams of a low Glycemic Index carbohydrate per teaspoon of SES. More preferably, the sweetening compositions of the present invention contain from about 4 grams to about 5 grams of a low Glycemic Index carbohydrate per teaspoon of SES.

The sweetening compositions of the present invention contain less than about 3 kilocalories per gram of SES, preferably from about 0.1 to 3 kilocalories per gram of SES. More preferably, the sweetening compositions of the present invention contain from about 1 to 2 kilocalories per gram of sSES.

### Aroma

As used herein, the term “aroma” or “aroma component” means any food-grade volatile substance that may be employed to produce a desired scent, for example, when mixed with a foodstuff. Aromas useful in the present invention include, for example, essential oils (citrus oil), expressed oils (orange oil), distilled oils (rose oil), extracts (fruits), anethole (liquorice, anise seed, ouzo, fennel), anisole (anise seed), benzaldehyde (marzipan, almond), benzyl alcohol (marzipan, almond), camphor (cinnamomum camphora), cinnamaldehyde (cinnamon), citral (citronella oil, lemon oil), ethyl butanoate (pineapple), d-limonene (orange), eugenol (clove oil), furaneol (strawberry), furfural (caramel), linalool (coriander, rose wood), menthol (peppermint), methyl butanoate (apple, pineapple), methyl salicylate (oil of wintergreen), neral (orange flowers), nerolin (orange flowers), pentyl butanoate (pear, apricot), pentyl pentanoate (apple, pineapple), sotolon (maple syrup, curry, fennugreek), strawberry ketone (strawberry), substituted pyrazines, e.g., 2-ethoxy-3-isopropylpyrazine; 2-methoxy-3-sec-butylpyrazine; and 2-methoxy-3-methylpyrazine (toasted seeds of fenugreek, cumin, and coriander), thujone juniper, common sage, Nootka cypress, and wormwood), thymol (camphor-like), trimethylamine (fish), vanillin (vanilla), salts, derivatives, and combinations thereof. Preferred aroma components according to the present invention are essential oils (citrus oil), expressed oils (orange oil), distilled oils (rose oil), extracts (fruits), benzaldehyde, d-limonene, furfural, menthol, methyl butanoate, pentyl butanoate, and combinations thereof.

As used herein, “foodstuff” means any edible substance to which a sweetener may be added. Foodstuffs useful in the present invention include, for example, cereals, dairy products, beverages, e.g., coffee, tea, milk, and seltzer. Preferably the foodstuff is a beverage.

The aroma may be present in any amount in the composition. Preferably, the aroma is present in an amount from about 2- to about 100-times the detectable amount. More preferably, the aroma is present in an amount from about 2- to about 10-times the detectable amount. As used herein, “detectable amount” is the amount of the aroma required to produce a scent detectable in the foodstuff, which usually ranges from a few parts per billion to about one hundred parts per million.

The detectable amount is different for each aroma. For example, for aromas from dried ground products, the detectable amount ranges from about 200 to about 2,000 ppm; for aromas from essential oils, the detectable amount ranges from about 1 ppm to about 100 ppm in the finished product.

### Flavor

As used herein, the term “flavor” or “flavor component” means any food-grade material that may be added to the sweetening compositions to provide a desired flavor to a foodstuff. Flavors useful in the present invention include, for example, cream, hazelnut, vanilla, chocolate, cinnamon, pecan, lemon, lime, raspberry, peach, mango, vanillin, butter, butterscotch, tea, orange, tangerine, caramel, strawberry, banana, grape, plum, cherry, blueberry, pineapple, elderberry, watermelon, bubblegum, cantaloupe, guava, kiwi, papaya, coconut, mint, spearmint, derivatives, and combinations thereof.

Preferably, the flavor or aroma component in the sweetening composition of the present invention is lemon.

The compositions of the present invention may include additional additives. Additives useful in the present invention include, for example, texture enhancers, colors, food-grade gums, bitter suppressing agents, and combinations thereof.

### Texture Enhancers

As used herein, the term “texture enhancer” means any food-grade material that may be added to the present compositions to provide a desired texture to a foodstuff. Texture enhancers useful in the present invention include, for example, guar gum, alginate, taro gum, gellan gum, xanthium gum, amalose, amalopectin, konjac, and combinations thereof.

### Colors

As used herein, the term “color” means any substance that may be employed to produce a desired color. Coloring agents useful in the present invention include, for example, FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), Annatto Extract, Anthocyanis, Aronia/Redfruit, Beet Juice & Powder, Beta-Carotene, Beta-APO-8-Carotenal, Black Currant, Burnt Sugar, Canthaxanthin, Caramel, Carbo Medicinalis, Carmine, Carmine/Beta-Carotene, Carmine Blue, Carminic Acid, Carrot & Carrot Oils, Chlorophyll, Chlorophyllin, Cochineal Extract, Copper-Chlorophyll, Copper-Chlorophyllin, Curcumin, Curcumin/CU-Chlorophyllin, Elderberry, Grape & Grape Skin Extracts, Hibiscus, Lutein, Mixed Carotenoids, Paprika, Paprika Extract, Paprika Oleoresin, Riboflavin, Saffron, Spinach, Stinging Nettle, Titanium Dioxide, Turmeric, and combinations thereof.

Colors may be used in two ways. First, the color may be added to the sweetening compositions to impart a color to the sweetening composition. Such colored sweetening compositions allow the consumer to use the color to identify flavor or aroma included therein. For example, a red sweetening composition could indicate a strawberry flavor. Likewise, yellow could indicate a lemon flavor, orange could indicate an orange aroma, and brown could indicate a chocolate flavor. Second, the color may be added to the sweetening compositions to impart a color to the foodstuff to be customized without imparting a color to the sweetening composition itself. Such compositions would provide a burst of color upon addition to and dissolution in the foodstuff.

### Food-Grade Gums

As used herein, the term “food-grade gum” means any food-grade material that has the properties of a gum and is able to impart a pleasing mouth feel to a foodstuff. Examples of food-grade gums include pullan, gum arabic, gum karaya, gum tragacanth, gum ghatti, agar-agar, guar gum, locust bean gum, konjac, alginates, carrageenans, pectin, tara gum, xanthan gum, gellan gum, pullulan, curdlan, cellulose microcrystalline cellulose (MCC), carboxymethylcellulose (CMC) gum, methylcellulose (MC), hydroxypropyl methylcellulose (HPMC), gelatin, chitosan, and combinations thereof.

### Bitter Suppressing Agents

As used herein, the term “bitter suppressing agent” means any food-grade material that masks or blocks the taste of bitter substances and may be used to enhance the flavor of a beverage or other product including a sweetening composition and blocks and/or masks the bitter taste of substances in a high intensity sweetener (such as the metal ions, e.g., potassium ion, in acesulfame K). Non-limiting examples of a bitter suppressing agent according to the present invention include adenosine 5′ monophosphate; thymidine 5′ monophosphate; adenosine 5′ diphosphate; adenosine 3′ monophosphate; adenosine 5′-succinate; adenosine 5′ triphosphate; adenosine 2′ monophosphate; 5′-cytidylic acid; inosinic acid, maltol, aliphatic polyols, monellin, and thaumatin, ribonucleosides, ribonucleotides, deoxy analogues of ribonucleosides and ribonucleotides, D-galactose, phospholipids, cinnamic acid, derivatives, salts, and combinations thereof. Other examples of a bitter suppressing agent according to the present invention also include a mixture of natural flavors sold under the trademark “K-BLOCK” or “K-BLOCK II” (by Natura, Inc., Lansing, Mich., USA) and Firmenich flavoring product no. 501.482/TP 04.24 (Plainsboro, N.J.).

Preferably, the solid, unit dose, sweetening composition of the present invention contains sucralose as the sweetener, fructooligosaccharide as the low Glycemic Index carbohydrate, and lemon as the flavor and/or aroma component.

### Shapes

The sweetening compositions of the present invention may be in any convenient shape. Generally, the sweetening compositions of the present invention have a three-dimensional shape, which may be crushed if desired. Examples of shapes useful in the present invention include, for example, rectangular prisms and other flat-sided prisms, pyramids, spheres and portions of spheres, e.g., hemispheres and orange-section shapes, discs, wafers, tablets, donuts, letters, numbers, symbols, and the like. Sweetening compositions of the present invention may also be provided in any of the foregoing shapes with one end of a string imbedded therein, allowing the user to speed dissolution by agitating the sweetening composition in the same way one would steep a teabag. The un-imbedded end of the string may also have a tag attached that conveys a message, such as the source of the sweetening composition, to the user.

Moreover, the sweetening compositions may be in the shapes that serve to identify the producer or provider of the sweetening compositions, e.g., slogans or trademarks. For example, McNeil Nutritionals may choose a stylized letter “M”.

### Physical Features

Sweetening compositions of the present invention have a volume greater than 0.03 cubic centimeters (cm³), such as greater than about 0.125 cm³ per gram of SES. Preferably, the sweetening compositions of the present invention have a volume from about 0.03 cm³ to about 2 cm³ or from about 0.125 cm³ to about 2 cm³ per gram of SES. More preferably the sweetening compositions of the present invention have a volume from about 1 cm³ to about 1.5 cm³ per gram of SES.

Sweetening compositions of the present invention require a pressure of less than 200 grams per square millimeter to be crushed into smaller solid particles. Preferably, the sweetening compositions of the present invention require a pressure of less than about 100 grams per square millimeter, more preferably less than about 50 grams per square millimeter to be crushed into smaller solid particles.

### Packaging

The present invention may be delivered in any packaged form typically used for delivering multiple doses of solid, unit dose compositions. For example, individual sweetening compositions may be wrapped in paper, plastic, foil, or the like. This wrapping may carry a message from the manufacturer or supplier. If multiple copies of a sweetening composition of only one aroma, flavor, or a combination thereof are provided they may be packaged in a hand-held dispenser with a small, resealable opening allowing the dispensing of the sweetening compositions one at a time. If two or more sweetening compositions are provided with different flavors, aromas, or combinations thereof, they may be provided in a tray where each sweetening composition may be individually identified or, if present, groups of more than one of the same sweetening composition may be identified, for example, by row or column. The sweetening compositions may also be packaged in deformable, plastic trays whose openings are sealed with a foil or plastic film, much like the packaging of many pharmaceuticals. The sweetening compositions may then be dispensed by pushing them through the foil or film.

### Producing Solid, Unit Dose, Sweetening Compositions

The solid, unit dose, sweetening compositions of the present invention are generally produced by a process having the following steps: (a) blending the ingredients, (b) forming the composition into the desired shape, and (c) drying the composition. Obviously, each step may have a number of variations.

While the manner in which the ingredients are blended is not critical, it is imperative to have a uniform distribution of the ingredients throughout the blend. Otherwise, both the sweetness and the caloric burden will vary from unit dose to unit dose. For ingredients used in small amounts it may be necessary to produce a pre-blend to ensure even distribution. If an ingredient tends to cake or lump, it may need to be passed through a sieve. The most common blenders are those that allow for continuous addition of ingredients.

In the present invention, the unit doses may take the form of cubes. Forming such cubes generally has two phases. First, the blended ingredients are hydrated to a moisture content from about 0.3% to about 3%, usually by the introduction of water or steam. Second, the hydrated ingredients are placed into dyes or molds and compressed to form the desired shape, e.g., a cube. The hydrated mixture may also be formed into large blocks and later broken into “rough cut” shapes.

Once the hydrated mixture has been formed into the desired shape it is dried. Drying may be accomplished using ovens or, if conditions permit, by exposure to ambient air. The most common dryers are continuous bands passing through a drying tunnel. Drying temperatures and times vary considerably. For example, in ambient air the drying time may be 24 hours. In contrast, drying in an oven from about 60° C. to about 75° C. can take as little as about 10 to about 20 minutes. A conditioning step may also be required after oven or air-drying of from about 12 to about 36 hours to allow moisture to equilibrate throughout the products.

### Kits

An additional embodiment of the present invention is a kit containing, in packaged combination, a plurality of unit dose, sweetening compositions and instructions for their use. In this kit, each sweetening composition contains a sweetener that provides at least about one gram of SES to the composition, at least about one gram of a low Glycemic Index carbohydrate per teaspoon of SES, and at least one flavor or aroma component, wherein a flavor of at least one unit dose in the kit differs from a flavor of at least one other unit dose in the kit.

Kits of the present invention may contain 100 or more different unit dose, sweetening compositions. Only the number of flavors, aromas, and combinations available limits the number of unit dose, sweetening compositions in a kit. Preferably, the kit contains from about 2 to about 15 unit dose, sweetening compositions. More preferably, the kit contains from about 3 to about 10 unit dose, sweetening compositions. Even more preferably the kit contains about 5 unit dose, sweetening compositions. Moreover, a kit may contain more than one unit dose of the same flavor or aroma. Preferably, the kit contains at least two unit doses of the same flavor or aroma. In another preferred embodiment, the kit has at least two unit does that have a different flavor or aroma.

This flexibility in the components of the kits allows for the production of kits tailored to individual consumers or for specific purposes. For example, a kit to provide a tropical experience might contain sweetening compositions having tropical fruit flavors/aromas, e.g., orange, mango, pineapple, lemon, and coconut. A kit having unit doses of five different flavors or aromas, such as this, could be used to produce 55 unique experiences if three of the sweetening compositions are combined in, for example, seltzer water. Kits may be designed to ease the transition from one part of the day to another. By using invigorating, bright flavors/aromas a kit to ease the transition from morning to afternoon could be produced. A kit for use in coffee may be kept in the consumer's desk drawer to enhance her morning coffee ritual without the need to stop at an expensive, crowded coffee shop.

A kit containing a modest number of unit doses of different flavors or aromas may be used to produce a large number of unique taste experiences. Tables 1 and 2 show the number of unique taste experiences available for kits having 5 and 15 unit doses of different flavors or aromas, respectively.

TABLE 1
Number of unique taste experiences for a 5-unit dose kit using up to 10 unit doses.

| | Number of Unit Doses Used | | | | | | | | | |
|---|---|---|---|---|---|---|---|---|---|---|
| | 1 | 2 | 3 | 4 | 5 | 6 | 7 | 8 | 9 | 10 |
| Total Number of Unique | 5 | 20 | 55 | 125 | 251 | 461 | 791 | 1286 | 2001 | 3002 |
| Taste Experiences | | | | | | | | | | |

TABLE 2
Number of unique taste experiences for a 15-unit dose kit using up to 10 unit doses.

| | Number of Unit Doses Used | | | | | | | | | |
|---|---|---|---|---|---|---|---|---|---|---|
| | 1 | 2 | 3 | 4 | 5 | 6 | 7 | 8 | 9 | 10 |
| Total | 15 | 135 | 815 | 3875 | 15503 | 54263 | 170543 | 490313 | 1307503 | 3268759 |
| Number of | | | | | | | | | | |
| Unique | | | | | | | | | | |
| Taste | | | | | | | | | | |
| Experiences | | | | | | | | | | |

In this kit, the composition and quantity of the sweetener, low Glycemic Index carbohydrate, flavor and aroma components are as described above.

### Customizing Taste of Food

Another embodiment of the present invention is a method of customizing the taste of a foodstuff. This method includes the steps of combining the foodstuff with a solid, unit dose, sweetening composition. The sweetening composition contains a sweetener that provides at least about one gram of SES to the composition, at least about one gram of a low Glycemic Index carbohydrate per teaspoon of SES, and at least one flavor or aroma component.

Preferably, the method of customizing the taste of a foodstuff entails mixing two or more of the solid, unit dose, sweetening compositions with the foodstuff.

In this method, the composition and quantity of the sweetener, low Glycemic Index carbohydrate, flavor and aroma components are as described above.

Another embodiment of the present invention is a method of customizing the taste of a foodstuff using a kit. In this method, a kit according to the present invention is provided. At least one unit dose is selected from the kit and combined with a foodstuff. In this manner, the taste of the foodstuff may be adjusted to suit the preferences of an individual.

In this method, two or more unit doses of the same flavor may be selected. Alternatively, one or more of unit doses of at least two different flavors may be selected to be incorporated into the foodstuff.

### Assessing Sweetness Profile and Designing Sweetness Delivery System

Another embodiment of the present invention is a method of assessing a sweetness profile of an individual and designing a customized sweetness delivery system for the individual. This method includes providing a kit containing, in packaged combination, a plurality of unit dose, sweetening compositions and instructions for their use. Each sweetening composition contains a sweetener that provides at least about one gram of SES to the composition, at least about one gram of a low Glycemic Index carbohydrate per teaspoon of SES, and at least one flavor or aroma component, wherein each unit dose provides a unique flavor.

The method further includes separately incorporating each unit dose into a sample of a foodstuff, determining the individual's preference for each of the unit dose flavors when combined with a sample of the foodstuff, correlating the individual's preferences for each flavor or aroma, and designing a customized sweetness delivery system based on the observed correlations. The examples below provide representative methods for determining an individual's preference for, e.g., a flavor, correlating the individual's preferences for a series of unit doses and designing a customized delivery system based on the individual's preferences.

In this method, the sweetening compositions have the same composition and quantity of the sweetener, low Glycemic Index carbohydrate, flavor and aroma components as described above.

These preferred sweet taste profiles may be used to produce customized delivery systems in the form of kits containing the preferred unit dose, sweetening compositions identified by the individual. As noted above the kits may be customized not only to the individual but also to the specific foodstuff or class of foodstuffs.

An additional embodiment of the present invention is a customized sweetness delivery system in the form of a kit containing in packaged combination, a plurality of unit dose, sweetening compositions and instructions for their use. Each sweetening composition contains a sweetener that provides at least about one gram of SES to the composition, at least about one gram of a low Glycemic Index carbohydrate per teaspoon of SES, and at least one flavor or aroma component. The composition of the unit doses in the system are determined by carrying out the method of assessing a sweetness profile of an individual described above.

In this system, the sweetening compositions have the same composition and quantity of the sweetener, low Glycemic Index carbohydrate, flavor and aroma components as described above.

The following examples are provided to further illustrate the compositions and methods of the present invention. These examples are illustrative only and are not intended to limit the scope of the invention in any way.

### EXAMPLES

### Example 1

Sweetening compositions of the present invention are made containing the following ingredients:

0.4% (wt) sucralose

98.6% (wt) fructooligosaccharide

1% (wt) flavor and/or aroma.

The ingredients are blended for 20 minutes on laboratory powder blender until uniform. The approximately 30 grams of the blended mix is then spread evenly over a chopping board to produce a thin layer. Approximately 1 to 3 milliliters of distilled water is sprayed over the over blended mix layer using an aerosol dispenser. The blended mix is then mixed by hand using spatula or knife to ensure even distribution of water throughout the blended mix. The blended mix is placed into a cube mold consisting of a dye having twenty-five 12×12×10 millimeter depressions. The cubes weigh 0.95 to 1.10. The blended mix is compressed in each depression with a 12×12 millimeter push. Additional blended mix is loaded into the depressions and compressed by hand until no more powder can be accommodated by the depressions. The formed sweetening compositions are removed from the dye by pushing them onto a Teflon® baking tray and dried. The cubes had a sweetness density of approximately 0.65 cubic centimeter per SES, and contained of approximately 1 gram of soluble, low glycemic index fiber. The cubes contained approximately 0.75 kilocalories per gram SES.

Table 3 shows the various flavors, aromas, and combinations that are manufactured.

TABLE 3
Sweetening composition flavors, aromas, and combinations.
Flavor or Aroma

| Chocolate | Hazelnut | Orange | Raspberry | Pineapple | Vanilla |
|---|---|---|---|---|---|
| X | X | | | | |
| X | | X | | | |
| | | X | | X | |
| | | X | X | X | |
| | | | X | | X |
| | | X | | | X |

### Example 2

A kit comprising a set of 25 unit dose, sweetening compositions, each produced as in Example 1 is provided. The sweetening compositions in the kit are:

1. cream

2. hazelnut

3. vanilla

4. chocolate

5. cinnamon

6. pecan

7. lemon

8. lime

9. raspberry

10. peach

11. mango

12. kiwi

13. butter

14. butterscotch

15. tea

16. orange

17. mint

18. caramel

19. strawberry

20. banana

21. grape

22. cherry

23. pineapple

24. papaya

25. coconut

Four individuals are evaluated. The unit dose, sweetening compositions of the kit are separately dissolved and mixed into 8 ounces each of coffee, seltzer, and oatmeal. A portion of each sweetening composition/foodstuff mixture is then consumed by each of the individuals. Each individual then indicates a strong preference (S), a preference (P), or no preference (unmarked) for each mixture. The taste preferences for the four individuals are shown in Table 4.

TABLE 4
Individual taste preferences.

| | Coffee | | | | Seltzer | | | | Oatmeal | | | |
|---|---|---|---|---|---|---|---|---|---|---|---|---|
| Individual | 1 | 2 | 3 | 4 | 1 | 2 | 3 | 4 | 1 | 2 | 3 | 4 |
| Sweetening | | | | | | | | | | | | |
| Composition | | | | | | | | | | | | |
| 1 | S | P | P | | | | | | S | | | |
| 2 | S | S | | | | | | | | | P | |
| 3 | | P | S | S | | P | S | | | | | |
| 4 | | | S | P | | | S | | P | | | P |
| 5 | S | P | | S | | | | | S | | S | P |
| 6 | | | | | | | | | | S | | |
| 7 | | | | | S | S | | P | | | | |
| 8 | | | | | S | S | | P | | | | |
| 9 | | | | P | S | | P | | | | | |
| 10 | | | | | | P | | S | | P | P | |
| 11 | | | | | | | | S | | | | |
| 12 | | | | | | | | | | | | |
| 13 | | | | | | | | | | P | | P |
| 14 | | | S | | | | | | P | S | | S |
| 15 | | | | | P | | P | | | | | |
| 16 | P | | | S | S | S | P | P | | | | |
| 17 | | P | | | | | | | | | | |
| 18 | S | | | P | | | | | P | S | S | |
| 19 | | | | | S | S | P | | | | | |
| 20 | | | | | | | | P | | | | |
| 21 | | | | | S | | | P | | | | |
| 22 | | | | | | P | S | S | | | | |
| 23 | | | | | | | P | | | | | |
| 24 | | | | | P | | | P | | | | |
| 25 | | P | P | | | S | | | | | | |

From these preferences, kits are produced for each of the individuals. In this Example, compositions for which an individual expressed a strong preference (S) or a preference (P) are included in the customized kits.

Customized kits for flavoring coffee for each of the individuals contain the following unit doses:
Individual 1: cream, hazelnut, cinnamon, orange, and caramel;
Individual 2: cream, hazelnut, vanilla, cinnamon, mint, and coconut;
Individual 3: cream, vanilla, chocolate, butterscotch, and coconut; and
Individual 4: vanilla, chocolate, cinnamon, raspberry, orange, and caramel.

Customized kits for flavoring seltzer for each of the individuals contain the following unit doses:
Individual 1: lemon, lime, raspberry, tea, orange, strawberry, grape, and papaya;
Individual 2: vanilla, lemon, lime, peach, orange, strawberry, cherry, and coconut;
Individual 3: vanilla, chocolate, raspberry, tea, orange, strawberry, cherry, and pineapple; and
Individual 4: lemon, lime, peach, mango, orange, banana, grape, cherry, and papaya.

Customized kits for flavoring oatmeal for each of the individuals contain the following unit doses:
Individual 1: cream, chocolate, cinnamon, butterscotch, and caramel;
Individual 2: pecan, peach, butter, butterscotch, and caramel;
Individual 3: hazelnut, cinnamon, peach, and caramel; and
Individual 4: chocolate, cinnamon, butter, and butterscotch.

### Example 3

Sweetening compositions of the present invention are made containing the following ingredients:

0.8% (wt) sucralose,
97.8% (wt) fructooligosaccharide, and
1% (wt) orange/pineapple flavor.

The ingredients are blended for 20 minutes on laboratory powder blender until uniform. The approximately 30 grams of the blended mix is then spread evenly over a chopping board to produce a thin layer. Approximately 1 to 3 milliliters of distilled water is sprayed over the over blended mix layer using an aerosol dispenser. The blended mix is then mixed by hand using spatula or knife to ensure even distribution of water throughout the blended mix. The blended mix is placed into a cube mold consisting of a dye having twenty-five 12×12×10 millimeter depressions. The cubes weigh 0.95 to 1.10. The blended mix is compressed in each depression with a 12×12 millimeter push. Additional blended mix is loaded into the depressions and compressed by hand until no more powder can be accommodated by the depressions. The formed sweetening compositions are removed from the dye by pushing them onto a Teflon® baking tray and dried. The cubes had a sweetness density of approximately 0.32 cubic centimeter per SES, and contained of approximately 1 gram of soluble, low glycemic index fiber. The cubes contained approximately 0.375 kilocalories per gram SES.

### Example 4

Sweetening compositions of the present invention are made containing the following ingredients:

0.1% (wt) sucralose,

98.9% (wt) tagatose, and

1% (wt) orange/pineapple flavor.

The ingredients are blended for 20 minutes on laboratory powder blender until uniform. The approximately 30 grams of the blended mix is then spread evenly over a chopping board to produce a thin layer. Approximately 1 to 3 milliliters of distilled water is sprayed over the over blended mix layer using an aerosol dispenser. The blended mix is then mixed by hand using spatula or knife to ensure even distribution of water throughout the blended mix. The blended mix is placed into a cube mold consisting of a dye having twenty-five 12×12×10 millimeter depressions. The cubes weigh 0.95 to 1.10. The blended mix is compressed in each depression with a 12×12 millimeter push. Additional blended mix is loaded into the depressions and compressed by hand until no more powder can be accommodated by the depressions. The formed sweetening compositions are removed from the dye by pushing them onto a Teflon® baking tray and dried. The cubes had a sweetness density of approximately 2.6 cubic centimeter per SES, and contained of approximately 1 gram of soluble, low glycemic index fiber. The cubes contained approximately 2.7 kilocalories per gram SES.

### Example 5

Sweetening compositions of the present invention are made containing the following ingredients:

0.1% (wt) sucralose,

97.8% (wt) tagatose, and

1% (wt) orange/pineapple flavor.

The ingredients are blended for 20 minutes on laboratory powder blender until uniform. The approximately 30 grams of the blended mix is then spread evenly over a chopping board to produce a thin layer. Approximately 1 to 3 milliliters of distilled water is sprayed over the over blended mix layer using an aerosol dispenser. The blended mix is then mixed by hand using spatula or knife to ensure even distribution of water throughout the blended mix. The blended mix is placed into a cube mold consisting of a dye having twenty-five 12×12×10 millimeter depressions. The cubes weigh 0.95 to 1.10. The blended mix is compressed in each depression with a 12×12 millimeter push. Additional blended mix is loaded into the depressions and compressed by hand until no more powder can be accommodated by the depressions. The formed sweetening compositions are removed from the dye by pushing them onto a Teflon® baking tray and dried. The cubes had a sweetness density of approximately 2.6 cubic centimeter per SES, and contained of approximately 1 gram of soluble, low glycemic index fiber. The cubes contained approximately 2.7 kilocalories per gram SES.

### Example 6

Sweetening compositions of the present invention are made containing the following ingredients:

10% (wt) sucralose,

89% (wt) tagatose, and

1% (wt) orange/pineapple flavor.

The ingredients are blended for 20 minutes on laboratory powder blender until uniform. The approximately 30 grams of the blended mix is then spread evenly over a chopping board to produce a thin layer. Approximately 1 to 3 milliliters of distilled water is sprayed over the over blended mix layer using an aerosol dispenser. The blended mix is then mixed by hand using spatula or knife to ensure even distribution of water throughout the blended mix. The blended mix is placed into a cube mold consisting of a dye having twenty-five 12×12×10 millimeter depressions. The cubes weigh 0.95 to 1.10. The blended mix is compressed in each depression with a 12×12 millimeter push. Additional blended mix is loaded into the depressions and compressed by hand until no more powder can be accommodated by the depressions. The formed sweetening compositions are removed from the dye by pushing them onto a TEFLON® baking tray and dried. The cubes had a sweetness density of approximately 0.26 cubic centimeter per SES, and contained of approximately 1 gram of soluble, low glycemic index fiber. The cubes contained approximately 0.3 kilocalories per gram SES.

The scope of the present invention is not limited by the description, examples and suggested uses herein and modifications can be made without departing from the spirit of the invention. Thus, it is intended that the present invention cover modifications and variations of this invention provided that they come within the scope of the appended claims and their equivalent.

What is claimed is:

1. A solid, unit dose sweetening composition comprising:
a. a sweetener in an amount that provides at least about one gram of SES to the composition;
b. at least about one gram of a low Glycemic Index carbohydrate per teaspoon of SES; and
c. at least one flavor or aroma component, wherein the solid, unit dose sweetening composition has the following properties:
i. a volume greater than about 0.03 cm³ per gram of SES;
ii. requires a pressure of less than about 200 g/mm² to be crushed into smaller solid particles; and
iii. contains less than about 3 kilocalories per gram of SES.

2. A composition according to claim 1, wherein the low Glycemic Index carbohydrate is present in the composition of from about 1 gram to about 10 grams per teaspoon of SES.

3. A composition according to claim 2, wherein the low Glycemic Index carbohydrate is present in the composition of from about 4 grams to about 5 grams per teaspoon of SES.

4. A composition according to claim 1, wherein the composition comprises from about 1 gram to about 10 grams of SES.

5. A composition according to claim 4, wherein the composition comprises from about 1 gram to about 5 grams of SES.

6. A composition according to claim 1, wherein the volume of the composition is from about 0.03 cm³ to about 2 cm³ per gram of SES.

7. A composition according to claim 6, having wherein the volume of the composition is from about 1 cm³ to about 1.5 cm³ per gram of SES.

8. A composition according to claim 1 that requires a pressure less than about 100 g/mm² to be crushed into smaller solid particles.

9. A composition according to claim 8 that requires a pressure less than about 50 g/mm² to be crushed into smaller solid particles.

10. A composition according to claim 1, wherein the composition comprises from about 0.1 to about 3 kilocalories per gram of SES.

11. A composition according to claim 10, wherein the composition comprises from about 1 to about 2 kilocalorie per gram of SES.

12. A composition according to claim 1, wherein the sweetener is selected from the group consisting of corn syrup, glucose, fructose, tagatose, high fructose corn syrup, lactose, sucrose, trehalose, lactose, arabinose, trehalose, maltodextrin, soluble starch, inulin, a sugar alcohol, aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, stevia, thaumatin, salts, and combinations thereof.

13. A composition according to claim 12, wherein the sweetener is sucralose.

14. A composition according to claim 1, wherein the low Glycemic Index carbohydrate is selected from the group consisting of fructooligosaccharide, soluble fiber, glucooligosaccharide, inulin, galactooligosaccharide, erythritol, tagatose, and combinations thereof.

15. A composition according to claim 14, wherein the low Glycemic Index carbohydrate is fructooligosaccharide.

16. A composition according to claim 1, wherein the aroma component, if present, is selected from the group consisting of essential oils, expressed oils, distilled oils, extracts, anethole, anisole, benzaldehyde, benzyl alcohol, camphor, cinnamaldehyde, citral, ethyl butanoate, d-limonene, eugenol, furaneol, furfural, linalool, menthol, methyl butanoate, methyl salicylate, neral, nerolin, pentyl butanoate, pentyl pentanoate, sotolon, strawberry ketone, 2-ethoxy-3-isopropylpyrazine, 2-methoxy-3-sec-butylpyrazine, 2-methoxy-3-methylpyrazine, thujone, thymol, trimethylamine, vanillin, salts, and combinations thereof.

17. A composition according to claim 1, wherein the flavor, if present, is selected from the group consisting of cream, hazelnut, vanilla, chocolate, cinnamon, pecan, lemon, lime, raspberry, peach, mango, vanillin, butter, butterscotch, tea, orange, tangerine, caramel, strawberry, banana, grape, plum, cherry, blueberry, pineapple, elderberry, watermelon, bubblegum, cantaloupe, guava, kiwi, papaya, coconut, mint, spearmint, and combinations thereof.

18. A composition according to claim 1, wherein the sweetener is sucralose, the low Glycemic Index carbohydrate is fructooligosaccharide, and the flavor is lemon.

19. A method of customizing the taste of a foodstuff comprising combining the foodstuff with a solid, unit dose, sweetening composition comprising:
a. a sweetener that provides at least about 1 gram of SES to the composition;
b. at least about 1 gram of a low Glycemic Index carbohydrate or a soluble fiber per teaspoon of SES; and
c. at least one flavor or aroma component.

20. A method according to claim 19, wherein the combining step comprises mixing two or more of the unit doses with the foodstuff.

21. A method according to claim 19, wherein the sweetener is sucralose, the low Glycemic Index carbohydrate is fructooligosaccharide, and the flavor is lemon.

22. A method according to claim 19, wherein the sweetening composition has a volume greater than about 0.125 cm³ per gram of SES.

23. A method according to claim 19, wherein the sweetening composition requires a pressure of less than about 200 g/mm² to be crushed into smaller solid particles.

24. A method according to claim 19, wherein the sweetening composition contains less than about 3 kilocalories per gram of SES.

25. A kit comprising, in packaged combination, a plurality of unit dose, sweetening compositions and instructions for their use, each sweetening composition comprising:
a. a sweetener that provides at least about one gram of SES to the composition;
b. at least about one gram of a low Glycemic Index carbohydrate per teaspoon of SES; and
c. at least one flavor or aroma component,
wherein a flavor of at least one unit dose sweetening composition in the kit differs from a flavor of at least one other unit dose in the kit.

26. A kit according to claim 25, wherein at least 2 unit dose sweetening compositions have the same flavor.

27. A kit according to claim 25, wherein at least 2 unit doses sweetening compositions have a different flavor.

28. A kit according to claim 27, which comprises from about 2 to about 15 distinct flavors and each unit dose sweetening composition is imparted with one of the about 2 to about 15 flavors.

29. A kit according to claim 27, which comprises from about 3 to about 10 distinct flavors and each unit dose sweetening composition is imparted with one of the about 3 to about 10 flavors.

30. A kit according to claim 27, which comprises 5 flavors and each unit dose sweetening composition is imparted with one of the 5 flavors.

31. A kit according to claim 30 comprising 5 unit dose sweetening compositions of each of the about 5 flavors.

32. A kit according to claim 25, wherein at least 1 of the unit dose sweetening compositions has a volume greater than about 0.125 cm³ per gram of SES.

33. A kit according to claim 25, wherein at least one of the unit dose sweetening compositions requires a pressure of less than about 200 g/mm² to be crushed into smaller solid particles.

34. A kit according to claim 25, wherein at least one of the unit dose sweetening compositions contains less than 3 kilocalories per gram of SES.

35. A method of customizing the taste of a foodstuff comprising:
a. providing a kit according to claim 25;
b. selecting at least one unit dose sweetening composition; and
c. combining the at least one unit dose sweetening composition with a foodstuff.

36. A method according to claim 35, wherein two or more unit dose sweetening compositions of the same flavor are selected.

37. A method according to claim 35, wherein one or more unit dose sweetening composition(s) of at least two different flavors are selected.

38. A method of assessing a sweetness profile of an individual and designing a customized sweetness delivery system for the individual comprising:
A. providing a kit comprising, in packaged combination, a plurality of unit dose, sweetening compositions and instructions for their use, each unit dose sweetening composition comprising:
i. a sweetener that provides at least about one gram of SES to the composition,
ii. at least about one gram of a low Glycemic Index carbohydrate per teaspoon of SES, and
iii. at least one flavor or aroma component, wherein each unit dose sweetening composition provides a unique flavor;
B. separately incorporating each unit dose sweetening composition into a sample of a foodstuff;
C. determining the individual's preference for each of the unit dose sweetening composition's flavors when combined with a sample of the foodstuff;
D. correlating the individual's preferences for each flavor; and
E. designing a customized sweetness delivery system based on the correlations in D.

39. A method according to claim 38, wherein at least one of the unit dose sweetening compositions has a volume greater than about 0.125 cm³ per gram of SES.

40. A method according to claim 38, wherein at least one of the unit dose sweetening compositions requires a pressure of less than about 200 g/mm² to be crushed into smaller solid particles.

41. A method according to claim 38, wherein at least one of the unit dose sweetening compositions contains less than about 3 kilocalories per gram of SES.

42. A customized sweetness delivery system comprising a kit containing in packaged combination, a plurality of unit dose, sweetening compositions and instructions for their use, each sweetening composition comprising:
a. a sweetener that provides at least about one gram of SES to the composition;
b. at least about one gram of a low Glycemic Index carbohydrate per teaspoon of SES; and
c. at least one flavor or aroma component,
wherein composition of the unit doses are determined by carrying out the method of claim 38.

43. A customized sweetness delivery system according to claim 42, wherein at least one of the unit dose sweetening compositions has a volume greater than about 0.125 cm³ per gram of SES.

44. A customized sweetness delivery system according to claim 42, wherein at least one of the unit dose sweetening compositions requires a pressure of less than about 200 g/mm² to be crushed into smaller solid particles.

45. A customized sweetness delivery system according to claim 42, wherein at least one of the unit dose sweetening compositions contains less than about 3 kilocalories per gram of SES.
